(19) United States
(12) Patent Application Publication
(10) Pub. No.: US 2004/0264346 A1
(43) Pub. Date: Dec. 30, 2004

(54) Compatible type optical pick-up device for writing/reading data and method for operating the same

(76) Inventors: Jin-Jong Kim, Kyunggi-do (KR); Ho-Seop Jeong, Kyunggi-do (KR); Chon-Su Kyong, Seoul (KR)

Correspondence Address: GOTTLIEB RACKMAN & REISMAN PC, 270 MADISON AVENUE, 8TH FLOOR, NEW YORK, NY, 100160601

(21) Appl. No.: 10/871,171

(22) Filed: Jun. 17, 2004

(30) Foreign Application Priority Data
Jun. 26, 2003 (KR) 2003-42162

(51) Int. Cl. G11B 7/00

(52) U.S. Cl. 369/112.02; 369/47.19; 369/116

(57) ABSTRACT

Disclosed are a compatible type optical pick-up device for writing/reading data at a high density and a method for operating the optical pick-up device, thereby allowing the optical pick-up device to be easily assembled and improving optical efficiency. The compatible type optical pick-up device includes a laser beam source for outputting a laser beam having a writing mode power level for writing data from a disk, a collimator lens for collimating the laser beam outputted from the laser beam source, an optical attenuator located on an optical route of the laser beam passing through the collimator lens for attenuating the power of the laser beam, and an objective lens for converging the laser beam, incident thereon, onto the disk.

### BACKGROUND OF THE INVENTION

1. Field of the Invention

The present invention relates to a compatible type optical pick-up device for writing/reading data at a high density and a method for operating the same, and more particularly to a compatible type optical pick-up device for writing/reading data at a high density, which minimizes effects of mode hopping in a high-density optical system generated when output of a laser diode is converted from a reading mode power level to a writing mode power level, and a method for operating the optical pick-up device, thereby allowing the optical pick-up device to be easily assembled and improving optical efficiency.

2. Description of the Related Art

Recently, an optical pick-up device, which is one type of data storage media, has been developed from CDs and DVDs to Blu-ray and AOD pick-up device (hereinafter, referred to as a “BD pick-up device”) for storing data at a high-density.

The above high-density writing/reading optical pick-up device employs a light source for emitting a blue beam and an objective lens optimized so as to be suitable for a thickness of a board for picking up the blue beam, thus being capable of writing/reading data at a high-density.

However, since the blue beam is used in the BD Pickup the BD pick-up has variation of refractive index in an optical medium higher than a red beam used in the CDs or DVDs, the BD pick-up device is disadvantageous in that it is difficult to design compensated system for the chromatic aberration.

Further, since mode hopping in the above-described high-density writing/reading optical pick-up device, generated when the output of a laser diode is converted from a reading mode power level to a writing mode power level, momentarily converts wavelength by several tens of μs, the high-density writing/reading optical pick-up device requires an optical system for compensating for the chromatic aberration generated thereby.

FIG. 1a is a graph illustrating aberration characteristics obtained by using one or two conventional objective lenses. Aberration (A), obtained by using one or two conventional objective lenses, has a symmetrical shape centering on a designed central wavelength similar to a parabola. Compensated aberration (B) in FIG. 1a is obtained by compensating for a defocusing amount, generated by the variation in wavelength, using an actuator.

After a pick-up device is operated, the temperature of the environs of the pick-up device is slowly increased. A wavelength of a laser diode (LD) varies according to the increase of the temperature of the environs of the pick-up device. Such variation in the wavelength of the laser diode can be sufficiently compensated for by using the actuator.

However, in case that the output of the laser diode is converted from a reading mode power level to a writing mode power level, as shown in FIG. 2, the above-described mode hopping is generated by the change of the output of the laser diode, thus causing the wavelength to be shifted.

For example, in case that the output intensity of the laser diode is shifted from the reading mode power level of 10 mW to the writing mode power level of 80 mW, the mode hopping is generated and the wavelength is shifted by approximately 1 nm to 1.5 nm (from λ₁ to λ₂). Here, a time taken to shift the wavelength is very short, less than several tens of μs, while a time taken to compensate for the wavelength by means of the actuator is several tens of ms. Accordingly, in case that the output of the laser diode is converted from the reading mode power level to the writing mode power level, as shown in FIG. 3, a writing area corresponding to several tens of ms is lost.

In order to solve such a problem, an optical system having aberration characteristics as shown in FIG. 1b is required.

That is, when the aberration has a value less than a target. RMS value shown by a dotted line, the aberration has desired characteristics although the mode hopping is generated. Here, A′ represents aberration obtained by using a lens group in which chromatic aberration is compensated for, and B′ represents compensated aberration obtained by compensating for a defocusing amount, generated according to wavelength, by means of an actuator.

In order to achieve the optical system having the aberration characteristics as shown in FIG. 1b, the optical system has a comparatively complicated structure, as follows.

First, as shown in FIG. 4a, an optical system comprises two collimator lenses 1 and 2 and two objective lenses 3. One collimator lens 1 is installed such that it moves back and forth. Here, D represents a disk.

The above optical system has many components, thus alleviating tolerance characteristics between the components and assembly tolerance characteristics, causing a difficulty in compatibility, and increasing production cost.

Such problems cause a difficulty in mass-production of the optical system.

FIG. 4b is a schematic view of an optical system including a diffractive optical element (DOE) Doublet lens. As shown in FIG. 4b, the optical system includes the DOE Doublet lens 4 for compensating the aberration, and an objective lens 5.

The DOE Doublet lens 4 is provided with a diffractive plane at one surface thereof opposite to the objective lens 5. The above optical system requires the DOE Doublet lens 4, which is expensive, thus being disadvantageous in that production cost of the optical system is increased and it is difficult to mass-produce the optical system due to high manufacturing tolerance.

Further, as shown in FIG. 4c, an optical system including a double-sided DOE lens 6 is prepared.

The double-sided DOE lens 6 is an aspherical lens provided with diffractive planes at both surfaces thereof. The optical system is advantageous in that it has a small number of components. However, since the aspherical double-sided DOE lens 6 is manufactured by a complicated process and optical efficiency of the double-sided DOE lens 6 is poor, it is difficult to mass-produce the double-sided DOE lens 6 in the same manner as the earlier cases.

As described above, it is difficult to design and manufacture an optical system having aberration with a value, less than a target RMS value, by modifying a structure of a lens. Accordingly, there is required a simple method for manufacturing an optical system having aberration with a value, less than the target RMS value.

### SUMMARY OF THE INVENTION

Therefore, the present invention has been made in view of the above problems, and it is an object of the present invention to provide a compatible type optical pick-up device for writing/reading data at a high density, which minimizes mode hopping, generated when the output of a laser diode is converted from a reading mode power level to a writing mode power level, simplifies a structure of an optical system, is easily assembled, and improves optical efficiency, and a method for operating the optical pick-up device.

In accordance with one aspect of the present invention, the above and other objects can be accomplished by the provision of a compatible type optical pick-up device for writing/reading data at a high density, comprising: a laser beam source for outputting a laser beam having a writing mode power level for writing data from a disk; a collimator lens for collimating the laser beam outputted from the laser beam source; an optical attenuator located on an optical route of the laser beam passing through the collimator lens for attenuating the power of the laser beam; and an objective lens for converging the laser beam, incident thereon, onto the disk.

Preferably, the optical attenuator may attenuate the output of the laser beam outputted from the laser beam source from the reading mode power level to a reading mode power level.

Further, preferably, the optical attenuator may be an optically transparent element, and have a response time less than 40 μs.

Moreover, preferably, the optical attenuator may be one selected from the group consisting of a liquid crystal shutter, which converts a direction of a polarized beam by retardation achieved by applying a voltage to a liquid crystal; a liquid crystal DOE, which is switched on/off by forming a DOE pattern formed on a sheet glass and then by injecting a liquid crystal into the DOE pattern; an AO modulator, which causes active diffraction grating by applying a longitudinal wave having an RF frequency onto an optical crystal; and an EO/MO modulator, which modulates optical power by changing polarized light by applying an electric or magnetic field to a non-linear crystal.

In accordance with another aspect of the present invention, there is provided a method for operating a compatible type optical pick-up device for writing/reading data at a high density, comprising the steps of: (a) allowing a laser beam source to output a laser beam having a writing mode power level; (b) allowing the laser beam to pass through an optical attenuator for attenuating the output of the laser beam from the writing mode power level to a reading mode power level; (c) applying a servo-mechanism to the optical pick-up device; (d) reading data from a disk in a reading mode; and (e) switching off the optical attenuator so that the reading mode power level is returned to the writing mode power level so as to write data from the disk.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is a graph illustrating aberration characteristics obtained by using one or two conventional objective lenses;

FIG. 1b is a graph illustrating ideal aberration characteristics;

FIG. 2 is a graph illustrating wavelength variation according to the shift of optical output from a reading mode power level to a writing mode power level;

FIG. 3 is a graph illustrating the shift of optical output from the reading mode power level to the writing mode power level in a conventional optical system;

FIGS. 4a to 4c respectively illustrate conventional compensating optical systems, and more particularly:

FIG. 4a is a schematic view of an optical system including two collimator lenses and two objective lenses;

FIG. 4b is a schematic view of an optical system including a diffractive optical element (DOE) junction lens using a diffraction optical element; and

FIG. 4c is a schematic view of an optical system including a DOE lens provided with diffractive surfaces on both surfaces thereof;

FIG. 5 is a schematic view illustrating an optical system in accordance with the present invention;

FIG. 6 is a graph illustrating the shift of optical output from a reading mode power level to a writing mode power level, in the optical system in accordance with the present invention;

FIGS. 7a and 7b are schematic views illustrating function of an AO modulator;

FIG. 8 is a schematic view illustrating optical attenuation using an EO/MO modulator;

FIG. 9 is a schematic view illustrating optical attenuation using a liquid crystal shutter; and

FIGS. 10a and 10b are schematic views illustrating constitution and function of a liquid crystal DOE.

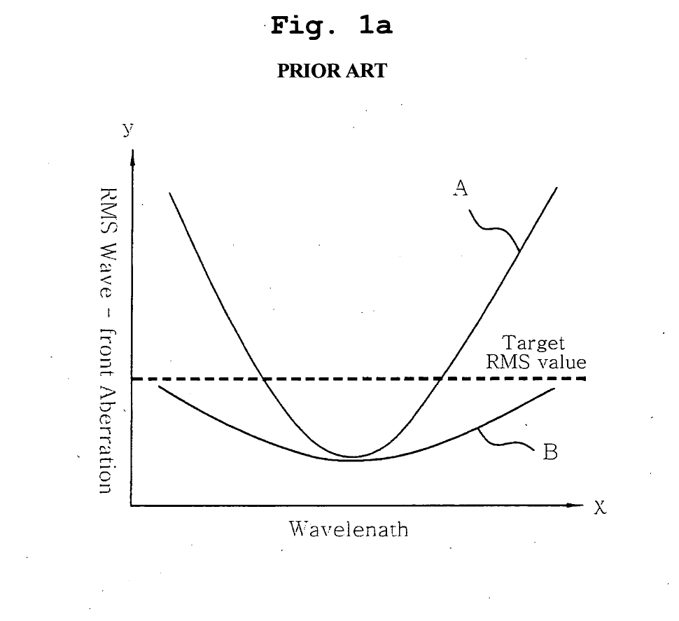

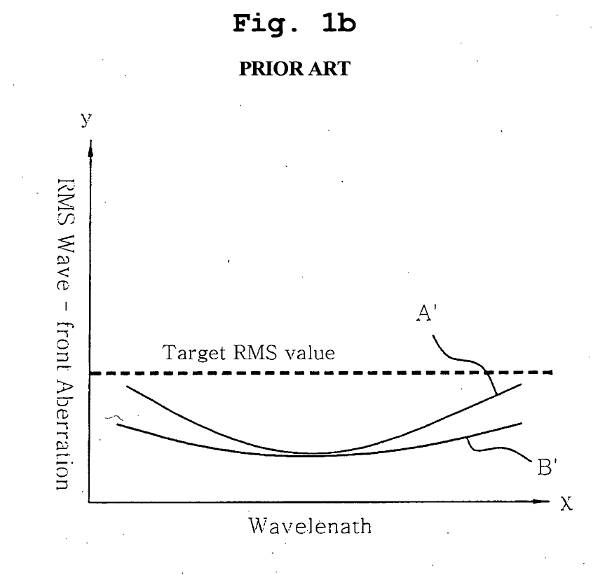

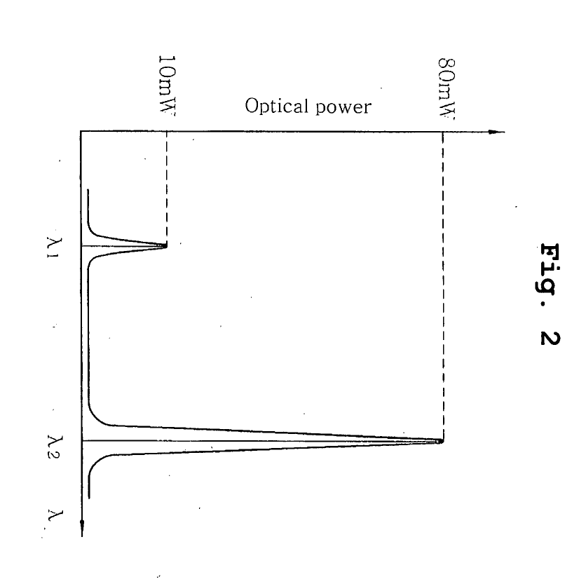

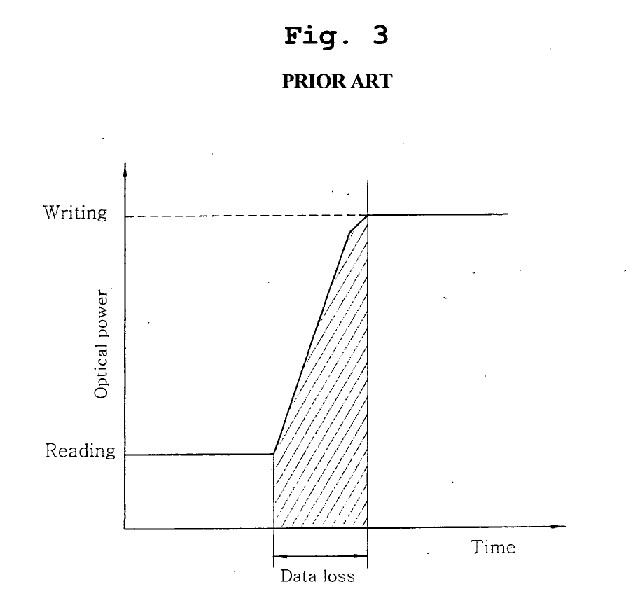

### DESCRIPTION OF THE PREFERRED EMBODIMENTS

Now, preferred embodiments of the present invention will be described in detail with reference to the annexed drawings.

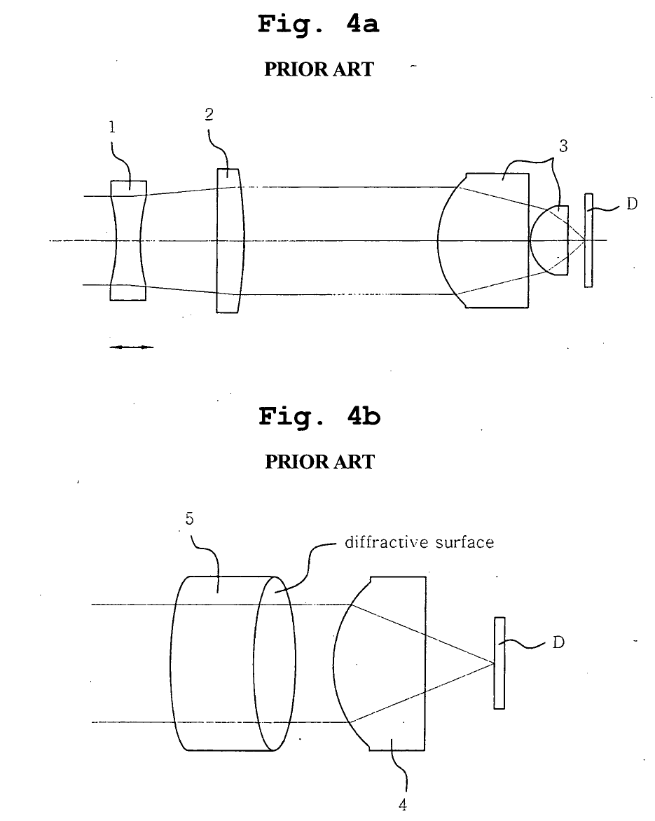

FIG. 5 is a schematic view illustrating an optical system in accordance with the present invention. The optical system comprises a laser diode 10 serving as a light source for emitting a laser beam, a collimator lens 11 for collimating the laser beam emitted from the laser diode 10, an optical attenuator 12, installed on a route of the laser beam passing through the collimator lens 11, for attenuating power of the laser beam, and an objective lens 13 for converging the incident laser beam into a disk (D).

Here, the laser diode 10 serves to output a laser beam having a writing-mode power level for writing data from a disk (D).

In this case, since the laser diode 10 emits the laser is beam having the writing mode power level rather than a reading mode power level, mode hopping caused by the conversion of the output power of the laser diode 10 from the reading mode power level to the writing mode power level has been generated already.

Since the optical pick-up device of the present invention comprises the optical attenuator 12, the laser beam having the writing mode power level outputted from the laser diode 10 passes through the collimator lens 11, and then reaches the optical attenuator 12, thereby being attenuated in terms of power.

The optical attenuator 12 of the optical pick-up device of the present invention attenuates power of the laser beam so that the laser beam having the writing mode power level outputted from the laser diode 10 is decreased into a laser beam having the reading mode power level.

Further, the optical attenuator 12 is optically transparent against a usable wavelength, and has a response time less than several tens of μs.

In case that the response time of the optical attenuator 12 is slow, an area of lost data is increased, thus making it difficult to apply the optical pick-up device of the present invention. Accordingly, the optical pick-up device of the present invention employs the optical attenuator 12 having a high speed less than several tens of μs.

Preferably, the response time of the optical attenuator 12 is 5˜40 μs. More preferably, the optical attenuator 12 having the response time less than 40 μs is suitable for the optical pick-up device of the present invention.

Further, in order to mass-produce the optical pick-up device comprising the optical attenuator 12, the optical attenuator 12 must be mass-produced at a reasonable price.

The optical attenuator 12 employed by the optical pick-up device of the present invention may be one selected from the group consisting of an AO modulator, an EO/MO modulator, a liquid crystal shutter, and a liquid crystal DOE.

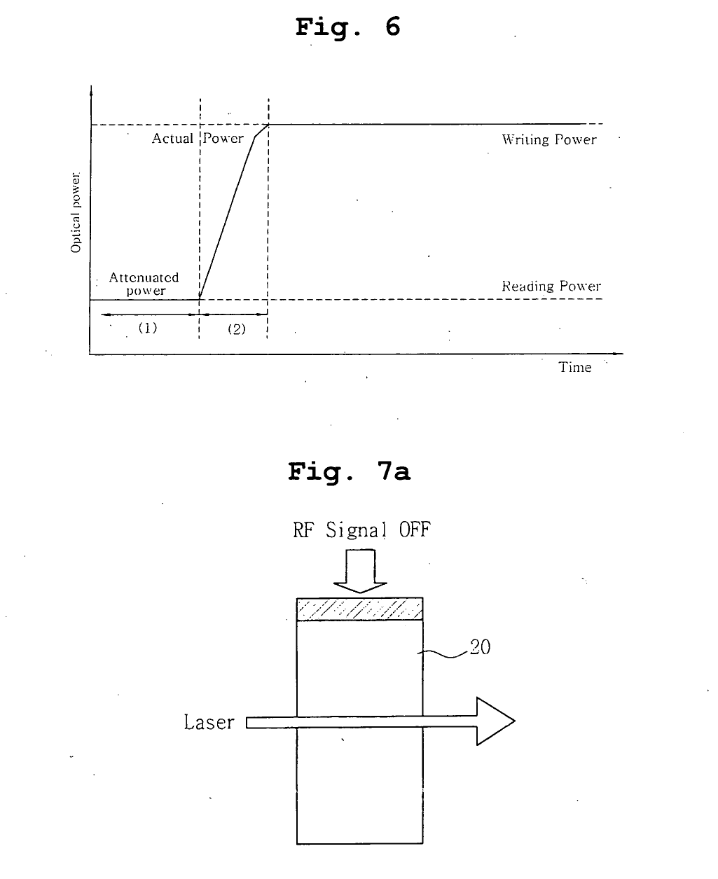

First, the AO modulator is an active diffraction grating which is made by applying a longitudinal wave having an RF frequency (hereinafter, referred to as an “RF signal”) to an optical special crystal. As shown in FIGS. 7a and 7b, in case that the RF signal is not applied to a crystal 20, a laser beam passes through the crystal 20 (FIG. 7a), but in case that the RF signal is applied to the crystal 20, diffraction grating is generated in the crystal 20 due to refractivity differences, and the laser beam is thus diffracted into several orders (FIG. 7b).

The response time of the AO modulator has a very short term such as several tens of ns. Thus, when the RF signal inputted to the AO modulator is adjusted, optical power is actively adjusted.

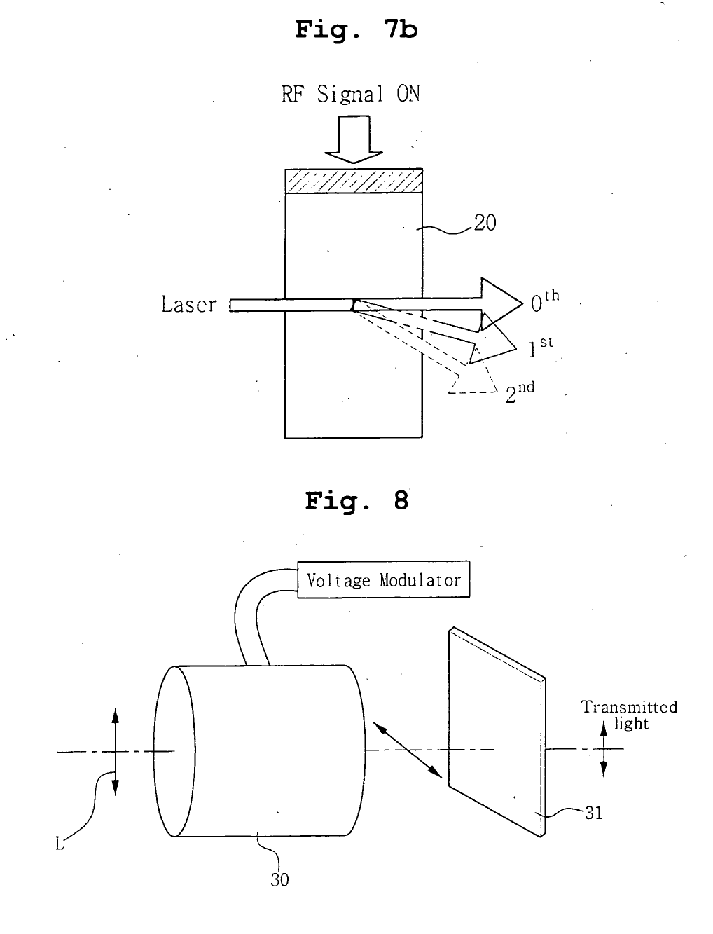

Second, the EO/MO modulator is an apparatus for modulating optical power by changing polarized light by applying an electric or magnetic field to a non-linear crystal. As shown in FIG. 8, when a voltage is applied to the EO/MO modulator 30, the EO/MO modulator 30 rotates a polarized beam (L) and then causes the polarized beam (L) to pass through a polarizer 31, thereby attenuating the beam. The response time of the EO/MO modulator 30 has a very short term such as several tens of ns. The EO/MO modulator is disadvantageous in that it requires a high voltage. However, a recently developed EO/MO modulator for optical communication is operated at a low voltage.

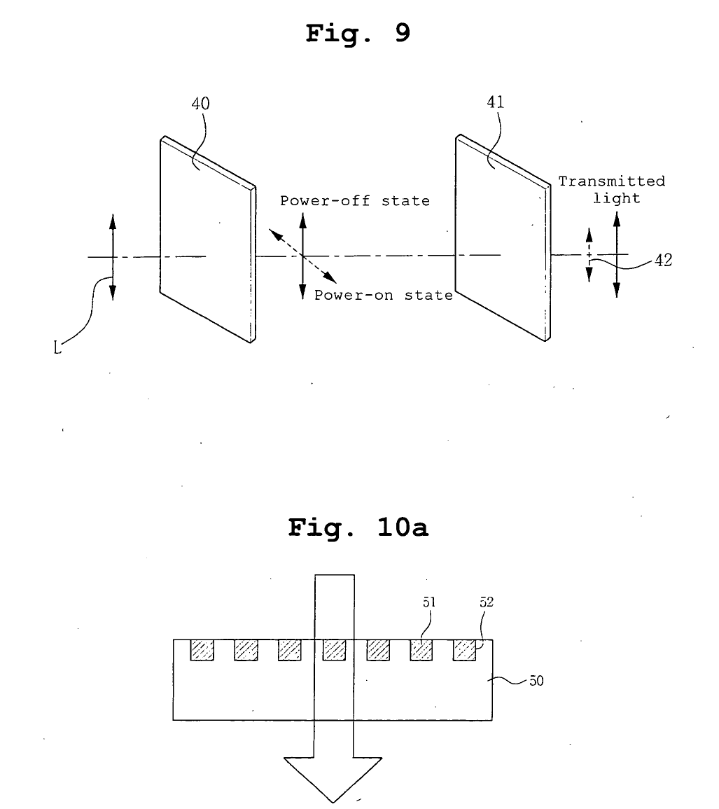

Third, a liquid crystal shutter adjusts a degree of a beam by change a direction of a polarized beam by retardation achieved by applying a voltage to a liquid crystal. As shown in FIG. 9, in case that a polarized beam (L) is incident into a liquid crystal shutter 40, the direction of the polarized beam (L) is not changed in a power-off state of the shutter 40. Thus, after the polarized beam passes through the polarizer 41, the beam is not attenuated.

However, in case that the liquid crystal shutter 40 becomes in a power-on state, since the polarized beam (L) is rotated, power of a beam 42 passing through the polarizer 41 is attenuated. Thereby, the power of the beam 42 can be modulated.

The response time of the liquid crystal shutter 40 can be several tens of μs. The response time of the liquid crystal shutter 40 has a comparatively low speed compared to those of the earlier-described optical attenuators, but is in the range of several μs to several tens of μs, thus achieving the object of the present invention. Accordingly, the liquid crystal shutter 40 can be used as the optical attenuator of the optical pick-up device of the present invention. Further, the liquid crystal shutter 40 is developed now for a displaying purpose, thus having stable operational characteristics.

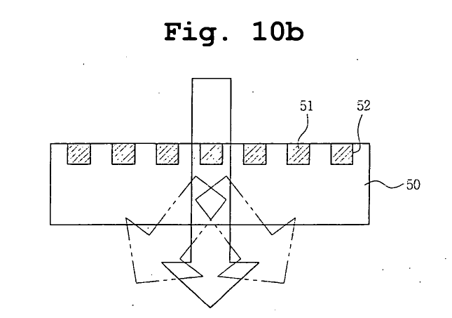

Fourth, the liquid crystal DOE, as shown in FIG. 10a, is electrically turned on/off by an EHOE type by forming a DOE pattern 52 formed on a sheet glass 50 and then by injecting a liquid crystal 51 into the DOE pattern 52. In the same manner as the liquid crystal shutter, the liquid crystal DOE has a response time in the range of several μs to several tens of μs, thus achieving the object of the present invention. Accordingly, the liquid crystal DOE can be used as the optical attenuator of the optical pick-up device of the present invention.

When an electric field is applied to the liquid crystal 51, crystal cells of the liquid crystal 51 are rotated and optical routes thereof vary, thereby causing refractivity to be changed. Accordingly, when an electric field is not applied to the liquid crystal 51, light can pass through the liquid crystal 51 without diffraction by making refractivity of the liquid crystal 51 and refractivity of the sheet glass 50 the same (FIG. 10a).

On the other hand, when an electric field is applied to the liquid crystal 51, the cells of the liquid crystal 51 are rotated, and the refractivity of the liquid crystal 51 differs from the refractivity of the sheet glass 50, thus forming diffraction grating. Thereby, as shown in FIG. 10b, the liquid crystal 51 diffracts light. By using the above principle, the liquid crystal DOE can modulate optical power.

Now, a method for operating the above compatible type optical pick-up device for writing/reading data at a high density in accordance with the present invention will be described in detail.

First, the laser diode 10 outputs a laser beam having a writing mode power level.

The laser beam passes through the collimator lens 11 so that the laser beam is collimated. The laser beam collimated by the collimator lens 11 reaches the optical attenuator 12, and then passes through the optical attenuator 12. Here, the optical attenuator 12 attenuates the power of the laser beam from the writing mode power level to the reading mode power level.

Here, the optical attenuator 12 is in a power-on state.

A servo-mechanism is applied to the optical pick-up device under the condition that the optical attenuator 12 is in the power-on state as described above.

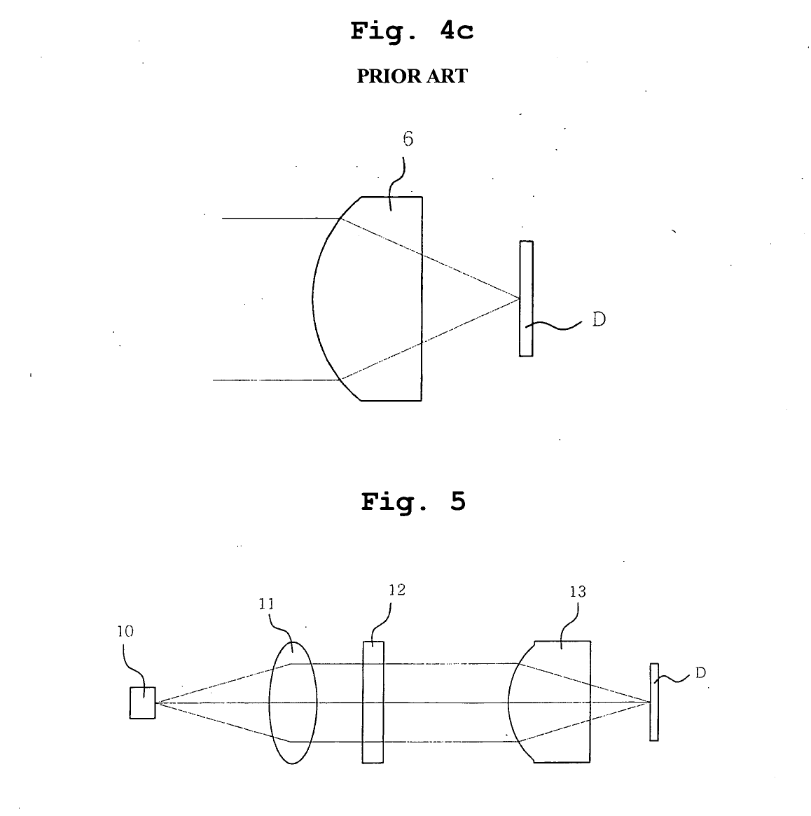

Then, as shown in FIG. 6, the output of the laser beam the optical pick-up device, which actually has a writing mode power level, is attenuated by the optical attenuator 12.

Accordingly, the optical pick-up device in the reading mode can read data of the disk (D).

Thereafter, in case that the output of the optical pick-up device is converted from the reading mode power level to the writing mode power level for writing data to the disk (D), the optical attenuator 12 is switched off.

Here, it takes the optical attenuator 12 time to respond to the conversion, thus generating a section (2) in FIG. 6.

The section (2) represents a response time of the optical attenuator 12, and varies according to the performance of the optical attenuator 12. In the present invention, the optical attenuator 12 has the response time less than several tens of μs so that the optical attenuator 12 rapidly responds to the conversion.

When the optical attenuator 12 is switched off, the laser beam maintains its output state in the writing mode power level. Thereby, the laser beam is returned to the writing mode power level, and the optical pick-up device can write data from the disk (D).

As described above, the optical pick-up device of the present invention does not generate mode hopping due to power conversion, thus having a desired aberration value or less, and being capable of writing data without the movement of an actuator.

That is, since the laser diode 10 of the optical pick-up device of the present invention outputs a laser beam having the writing mode power level, mode hopping is generated already. However, since the output of the laser diode 10 of the optical pick-up device of the present invention is converted from the reading mode power level to the writing mode power level by switching off the optical attenuator 12, mode hopping does not influence the optical pick-up device.

Accordingly, since the wavelength of the laser beam is not shifted momentarily, the optical pick-up device of the present invention can write data by means of a desired value of aberration without the movement of the actuator.

Further, a section (1) represents a time taken to apply a servo-mechanism to the optical pick-up device.

As apparent from the above description, the present invention provides a compatible type optical pick-up device for writing/reading data at a high density, which eliminates effects of mode hopping using an optical attenuator for attenuating the power of a laser beam emitted from a laser beam source, and a method for operating the optical pick-up device. Thereby, it is unnecessary to constitute an optical system having a complicated structure for compensating for aberration, and a simply constituted optical system is provided.

In case that the optical system has a simple constitution, the optical pick-up device is easily assembled, thus improving workability, productivity and optical efficiency. Further, in this case, the optical pick-up device is designed such that it is compatible with CDs and DVDs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A compatible type optical pick-up device for writing/reading data at a high density, comprising:
a laser beam source for outputting a laser beam having a writing mode power level for writing data from a disk;
a collimator lens for collimating the laser beam outputted from the laser beam source;
an optical attenuator located on an optical route of the laser beam passing through the collimator lens for attenuating the power of the laser beam; and
an objective lens for converging the laser beam, incident thereon, onto the disk.

2. The compatible type optical pick-up device as set forth in claim 1;
wherein the optical attenuator attenuates the output of the laser beam outputted from the laser beam source from the writing mode power level to a reading mode power level.

3. The compatible type optical pick-up device as set forth in claim 1 or 2,
wherein the optical attenuator is an optically transparent element.

4. The compatible type optical pick-up device as set forth in claim 1 or 2,
wherein the optical attenuator has a response time less than 40 μs.

5. The compatible type optical pick-up device as set forth in claim 1 or 2,
wherein the optical attenuator is a liquid crystal shutter, which converts a direction of a polarized beam by retardation achieved by applying a voltage to a liquid crystal.

6. The compatible type optical pick-up device as set forth in claim 1 or 2,
wherein the optical attenuator is a liquid crystal DOE, which is switched on/off by forming a DOE pattern formed on a sheet glass and then by injecting a liquid crystal into the DOE pattern.

7. The compatible type optical pick-up device as set forth in claim 1 or 2,
wherein the optical attenuator is an AO modulator, which causes active diffraction grating by applying a longitudinal wave having an RF frequency onto an optical crystal.

8. The compatible type optical pick-up device as set forth in claim 1 or 2,
wherein the optical attenuator is an EO/MO modulator, which modulates optical power by changing polarized light by applying an electric or magnetic field to a non-linear crystal.

9. A method for operating a compatible type optical pick-up device for writing/reading data at a high density, comprising the steps of:
(a) allowing a laser beam source to output a laser beam having a writing mode power level;
(b) allowing the laser beam to pass through an optical attenuator for attenuating the output of the laser beam from the writing mode power level to a reading mode power level;
(c) applying a servo-mechanism to the optical pick-up device;
(d) reading data from a disk in a reading mode; and
(e) switching off the optical attenuator so that the reading mode power level is returned to the writing mode power level so as to write data from the disk.
